(19) United States
(12) Patent Application Publication
(10) Pub. No.: US 2023/0387506 A1
(43) Pub. Date: Nov. 30, 2023

(54) INFORMATION TECHNOLOGY (IT) ENCLOSURE FOR BATTERY BACKUP SYSTEMS

(71) Applicant: Baidu USA LLC, Sunnyvale, CA (US)

(72) Inventor: Tianyi GAO, San Jose, CA (US)

(21) Appl. No.: 17/826,697

(22) Filed: May 27, 2022

(51) Int. Cl. H01M 10/6569; G06F 1/30; H01M 10/613; H01M 10/627; H02J 7/00

(52) U.S. Cl. CPC H01M 10/6569; G06F 1/30; H01M 10/613; H01M 10/627; H02J 7/007188

(57) ABSTRACT

Embodiments are disclosed of a battery backup unit (BBU). The BBU includes an information technology (IT) enclosure adapted to hold a two-phase cooling fluid. A battery stack is adapted to be positioned within the IT enclosure and submerged in the two-phase cooling fluid. The battery stack has N battery cells, N≥2, and each battery cell has a top surface. The battery cells are stacked in ascending order, the first battery cell being the lowest battery cell in the battery stack and the Nth battery cell being the highest battery cell in the battery stack. An initial distance between a surface of the two-phase cooling fluid and the top surface of the Nth battery cell, and an inter-cell distance between the top surfaces of each pair of consecutive battery cells in the stack, are determined based on the storage capacity of the battery cells and the thermal properties of the two-phase cooling fluid.

### TECHNICAL FIELD

The disclosed embodiments relate generally to battery backup units (BBUs) for information technology (IT) equipment and more specifically, but not exclusively, to a BBU with passive two-phase cooling.

### BACKGROUND

Modern data centers like cloud computing centers house enormous amounts of information technology (IT) equipment such as servers, blade servers, routers, edge servers, power supply units (PSUs), battery backup units (BBUs), etc. Individual pieces of IT equipment are typically housed in racks within the computing center, with multiple pieces of IT equipment in each rack. The racks are typically grouped into clusters within the data center.

The main power source for IT equipment in each rack is generally a facility power source, such as electricity provided to the data center by an electrical utility. BBUs, as their name implies, are intended to provide backup power to IT equipment in a rack when the main power source fails or must be taken offline for maintenance, or in other scenarios such as during peak power usage. When a BBU is providing power to IT equipment in a rack, energy storage units in the BBU, e.g. batteries, are discharging. When they are not providing power to the IT equipment the batteries are either idle (i.e., neither charging nor discharging) or are being charged by the main power source. Charging and discharging the batteries generates heat, meaning that at times batteries in a BBU can require cooling. Battery heating becomes more problematic as the power consumption of IT equipment in the rack increases: higher energy consumption requires a higher battery discharge rate that generates more heat, and faster battery charging similarly generates more heat. Existing solutions for battery backup units and systems still require power to run cooling systems that keep the battery functioning properly, but these battery cooling systems themselves require power, which is problematic when a BBU is used for backup power.

### BRIEF DESCRIPTION OF THE DRAWINGS

Non-limiting and non-exhaustive embodiments of the invention are described below with reference to the following figures, wherein like reference numerals refer to like parts throughout the various views unless otherwise specified.

FIG. 1 is a side view of an embodiment of a battery backup unit.

FIG. 2 is a side view of an embodiment of a multi-function unit.

FIG. 3 is a side view of another embodiment of a battery backup unit.

FIGS. 4A-4B are side views of an embodiment of a battery backup unit illustrating its operation.

FIG. 5 is a flowchart of an embodiment of the operation of a battery backup unit such as the BBU of FIGS. 4A-4B.

### DETAILED DESCRIPTION

Embodiments are described of a battery backup unit (BBU). Specific details are described to provide an understanding of the embodiments, but one skilled in the relevant art will recognize that the invention can be practiced without one or more of the described details or with other methods, components, materials, etc. In some instances, well-known structures, materials, or operations are not shown or described in detail but are nonetheless encompassed within the scope of the invention.

Reference throughout this specification to “one embodiment” or “an embodiment” means that a described feature, structure, or characteristic can be included in at least one described embodiment, so that appearances of “in one embodiment” or “in an embodiment” do not necessarily all refer to the same embodiment. Furthermore, the described features, structures, or characteristics can be combined in any suitable manner in one or more embodiments. As used in this appli-cation, directional terms such as “front,” “rear,” “top,” “bottom,” “side,” “lateral,” “longitudi-nal,” etc., refer to the orientations of embodiments as they are presented in the drawings, but any directional term should not be interpreted to imply or require a particular orientation of the described embodiments when in actual use.

Embodiments are described of battery backup unit (BBU) that efficiently manages cooling without the need for any additional power. It is a highly efficient solution. The BBU includes a multifunction unit that is used in an IT enclosure for stacking battery cells. The multifunction unit enables different battery cells to be stacked at different heights based on their designed discharging time and capacities. The height locations and the battery function are highly correlated and coupled. The battery cells are stacked on top of each other and submerged in the liquid phase of a two-phase cooling fluid. Battery cells in the battery stack are then discharged serially, in a sequence from the top battery cell in the stack to the bottom battery cell in the stack, and the battery discharge causes a decrease of the depth of the two-phase fluid. The embodiments offer a design for populating battery backup packs and operating them with extreme efficiency and availability. Features and benefits of the disclosed embodiments include:
Thermal management of high power-density energy units.
Actual scenario for running battery backup units.
High-efficiency two-phase coolant management.
High solution flexibilities that accommodate different server and IT systems and different backup time requirements.
Enhanced battery cell performance.
Enhanced battery backup time during discharge.
Ease of service and maintenance.
Highly scalable design for different deployment scales.

In one aspect, the battery backup unit (BBU) includes an information technology (IT) enclosure adapted to hold a two-phase cooling fluid. A battery stack is adapted to be positioned within the IT enclosure and submerged in the liquid phase of the two-phase cooling fluid. The battery stack includes N battery cells, N≥2, and each battery cell has a top surface. The battery cells are stacked in ascending order, with the first battery cell being the lowest battery cell in the battery stack and the Nth battery cell being the highest battery cell in the battery stack. An initial distance between a liquid surface of the two-phase cooling fluid and the top surface of the Nth battery cell, and an inter-cell distance between the top surfaces of each pair of consecutive battery cells in the stack, are determined based on the storage capacity of the battery cells and the thermal properties of the two-phase cooling fluid.

In one embodiment the thermal properties of the two-phase cooling fluid include its specific heat capacity and evaporation rate. In an embodiment each battery stack further includes a pair of multi-function units, wherein each multi-function unit includes a stacking structure with a set of supports and the distance between supports provides the required inter-cell distance for a given battery cell power capacity and wherein each battery cell in the battery stack is supported by a pair of corresponding supports, one from each multi-function unit.

In another embodiment the BBU further includes N liquid-level sensors, each liquid-level sensor substantially aligned with the top surface of a corresponding battery cell; N switches, each coupled to a corresponding battery cell; and a controller communicatively coupled to the N liquid-level sensors and the N switches, wherein the controller uses each switch to turn off the corresponding battery cell when the corresponding liquid-level sensor determines that the top surface of the battery cell is no longer submerged in the two-phase cooling fluid.

In other embodiments the BBU further comprises an electrical bus electrically coupled to the N battery cells in the battery stack and in yet another embodiment the BBU further comprises a vapor collector coupled to a top of the IT container. In an embodiment the vapor collector is internal, external, or partially internal and partially external. In another embodiment the vapor collector has a fluid inlet, a fluid outlet, and a pump coupled in the fluid inlet to circulate an external cooling fluid through the vapor collector.

In yet other embodiments, the BBU further includes at least one additional battery stack positioned in the IT container and submerged in the two-phase cooling fluid. In one embodiment the additional battery stack has M battery cells and M N.

In another aspect, a process of operating a battery backup unit (BBU) includes submerging a battery stack in a liquid phase of a two-phase cooling fluid, the battery stack including N battery cells, N≥2, each battery cell having a top surface. The battery cells are stacked in ascending order, the first battery cell being the lowest battery cell in the battery stack and the Nth battery cell being the highest battery cell in the battery stack. Each battery cell is discharged in a sequence starting with the Nth battery cell and proceeding in descending order to the first battery cell. Each battery cell is electrically discharged until a liquid surface of the two-phase cooling fluid substantially coincides with the top surface of the battery cell. When the liquid surface of the two-phase cooling fluid substantially coincides with the top surface of the battery cell, that battery cell stops discharging and the next battery cell in the sequence begins to discharge.

Some embodiments further include determining an initial distance between a surface of the two-phase cooling fluid and the top surface of the Nth battery cell, and an inter-cell distance between the top surfaces of each pair of consecutive battery cells in the stack, based on the storage capacity of the battery cells and the thermal properties of the two-phase cooling fluid. In an embodiment the thermal properties of the two-phase cooling fluid include its specific heat capacity and evaporation rate.

An embodiment further comprise supporting each battery cell in the battery stack with at least one multi-function unit having a set of N supports therein, the positions of the supports providing the inter-cell distance and the initial distance between a surface of the two-phase cooling fluid and the top surface of the Nth battery cell.

Another embodiment further includes aligning a liquid-level sensor with the top surface of each battery cell; coupling a switch to each battery cell; and turning off each switch when the corresponding liquid-level sensor determines that the top surface of the battery cell is no longer submerged in the two-phase cooling fluid.

Yet another embodiment further includes electrically coupling an electrical bus to the N battery cells in the battery stack. Other embodiments further include coupling a vapor collector to the IT container, and yet other embodiments further include circulating an external cooling fluid through the vapor collector. Other embodiments further include submerging at least one additional battery stack in the two-phase cooling fluid. In one embodiment the additional battery stack has M battery cells wherein M N.

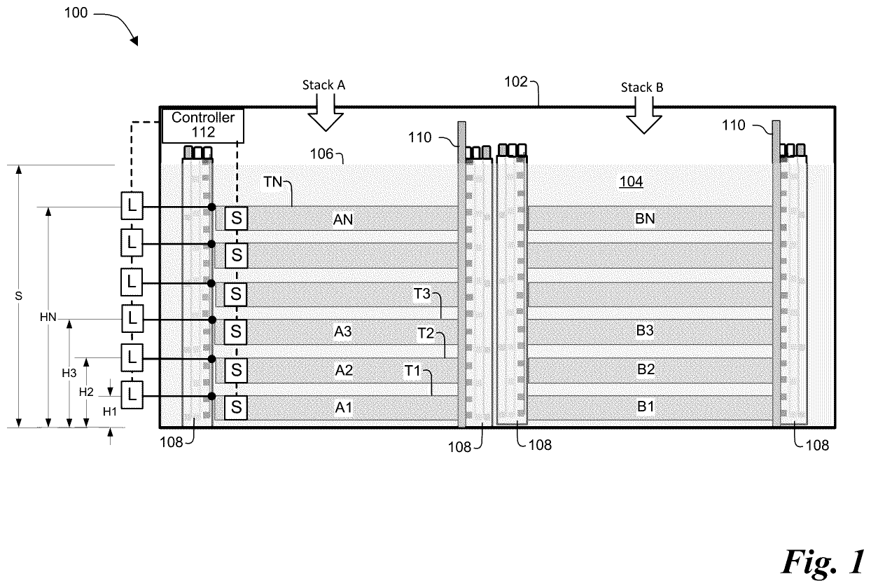

FIG. 1 illustrates an embodiment of a battery backup unit (BBU) 100. BBU 100 includes an information technology (IT) container 102 designed to be partially or fully filled with the liquid phase of a two-phase immersion cooling fluid 104. In the illustrated embodiment two-phase cooling fluid 104 is held in a lower portion of container 102, but in other embodiments the two-phase cooling fluid can be held in a different part of the IT container.

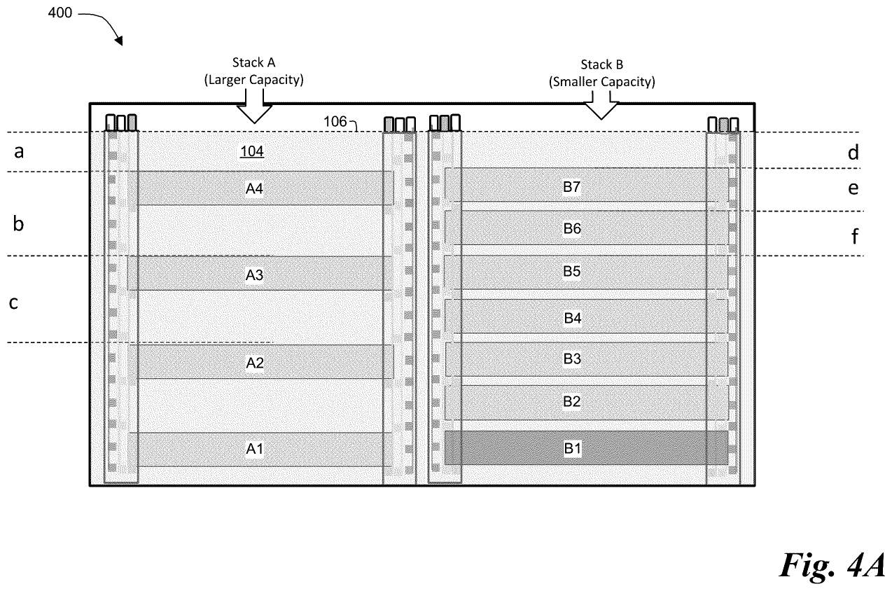

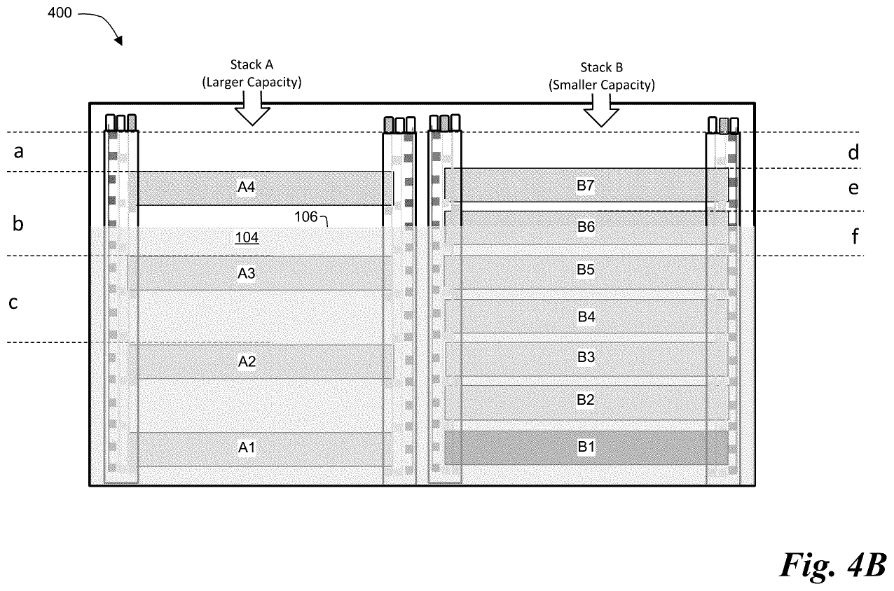

One or more battery stacks are positioned within IT container 102 and submerged in the liquid phase of two-phase cooling fluid 104. The illustrated embodiment has two battery stacks A and B, but other embodiments can include more or less battery stacks than shown. Each battery stack includes N individual battery cells, where N≥2. In the illustrated embodiment each battery stack has six battery cells (i.e., N=6), but in other embodiments each battery stack can have more or less battery cells than shown, and in embodiments with multiple battery stacks all stacks need not have the same number of battery cells (see, e.g., FIGS. 4A-4B). All battery cells in each stack are electrically coupled to an electrical bus 110, through which electrical power is delivered to other components in the IT container 102 such as servers or other types of IT equipment.

In each stack the battery cells are vertically stacked in ascending order. In stack A, for example, first battery cell A1 is at the bottom, second battery cell A2 is next above A1, third battery cell A3 is next above A2, and so on until the Nth battery cell AN, which is the top battery cell in the stack. Each battery cell A has a top surface T and is positioned in IT container 102 with its top surface T at a height H measured from the bottom of IT container 102. Thus, first battery cell A1 has its top surface T1 positioned at height H1, second battery cell A2 has its top surface T2 positioned at height H2, and so on until Nth battery cell AN, which has its top surface T positioned at height HN. Two-phase cooling fluid 104 has a liquid surface 106 that is at a height S—in other words, the liquid phase of cooling fluid 104 has a depth S. In the illustrated embodiment stack B is arranged the same as stack A, with the same number of battery cells at the same heights H, but in other embodiments the stacks need not have the same number of battery cells, nor need they be arranged at the same heights.

In this arrangement, the depth below liquid surface 106 of top surface TN of the Nth battery cell (i.e., distance S-HN) and the inter-cell distance between the top surfaces of each battery cell and the battery cell above it (e.g., H2−H1 for battery cell B1, H3−H2 for battery cell B2, and so on up to battery cell N−1) are determined based on the volume of cooling fluid 104 that each battery cell is expected to evaporate during discharge. The expected evaporation volume is in turn determined by the capacity of the battery cell, its expected thermal output during discharge, and the thermal properties of two-phase cooling fluid 104 such as its specific heat capacity and evaporation rate. The battery cell's capacity can, in one embodiment, be measured by the amount of time it can output the required amount of power.

During discharge of battery cells, the height S of liquid surface 106 will decrease as two-phase fluid 104 evaporates into its vapor phase due to heat from the discharging batteries. The distance between the top surface of the Nth battery and the initial position of liquid surface 106, and the distance between top surfaces of pairs of battery cells, are designed so that between when it begins discharging in one exhaust its capacity, each battery evaporates just enough two-phase cooling fluid to bring liquid surface 106 coincide with its top surface, at which point that particular battery ceases discharging. Further details of the operation of BBU 100 are described below in connection with FIGS. 4A-4B.

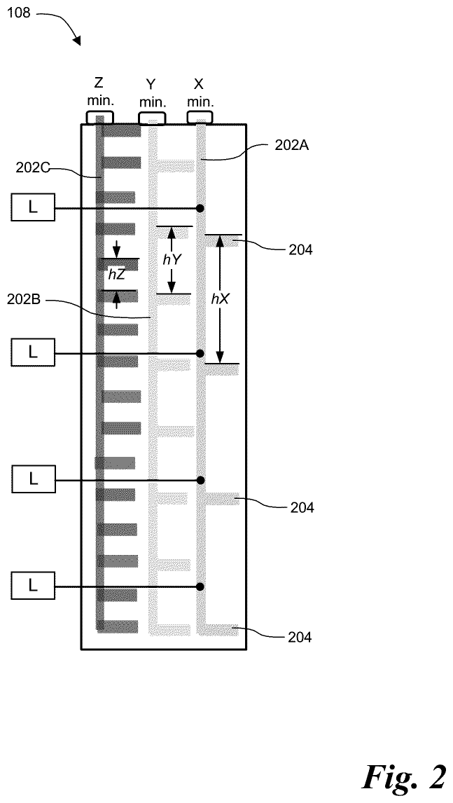

In each battery stack, each battery cell is supported at its height H by a pair of multi-function units 108 positioned on either end of the battery cell. Each multi-function unit 108 includes multiple supports, so that each battery cell is supported by a pair corresponding supports, one support in each multi-function unit. In one embodiment both multi-function units in each battery stack can be identical, but in other embodiment they can be different. In still other embodiments, the battery cells can be supported by a single multi-function unit instead of two. The multifunction unit can be a modular unit for the IT enclosure. An embodiment of a multi-function unit 108 is described below in connection with FIG. 2.

Some embodiments of BBU 100 can include can include additional element and controls, both for safety and to more accurately control the beginning and end of each battery cell's discharge with respect to the level of two-phase cooling fluid 104. In one embodiment, for instance, a number of fluid-level sensors L can be positioned so that each sensor detects when liquid surface 106 coincides with the top surface of each battery cell (e.g., the sensors detect when S=HN, S=H3, S=H2, etc.). Each battery cell can also include a corresponding switch S, and sensors L and switches S can be communicatively coupled to a controller 112. In operation, as the depth S of liquid surface 106 declines, each sensor L will sense the level of the liquid. When the liquid surface 106 reaches the top surface of each battery cell, controller 112 instructs that particular battery cell's switch S to stop discharging and instructs the next lower battery cell in the stack to start discharging. Other embodiments need not include sensors L, switches S, or controller 112.

FIG. 2 illustrates an embodiment of a multi-function unit 108. The battery cells in each battery stack are supported by a pair of multi-function units (see, e.g., FIG. 1), and each multi-function unit 108 includes one or more vertical stacking structures 202. The illustrated embodiment includes three stacking structures 202A, 202B, and 202C. Each stacking structure 202 includes multiple battery cell supports 204. In the illustrated embodiment battery cell supports 204 are arms that project laterally from the stacking structures, but in other embodiments battery cell supports 204 can be another type of structure, such as notches in the stacking structure. Each stacking structure 202 is designed to accommodate battery cells of a certain capacity, so that the spacing h between supports 204—hX for stacking structure 202A, hY for stacking structure 202B, etc.—is determined based on the capacity of the batteries that will be used with that stacking structure as well as the thermal characteristics of the two-phase cooling fluid in which the battery cells will be submerged. In the illustrated embodiment, stacking structure 202A has a support spacing hX designed for battery cells with a capacity of X minutes; stacking structure 202B has a support spacing hY designed for battery cells with a capacity of Y minutes; and so on. Distances hX, hY, and hZ can also be understood as the volume of two-phase fluid designed to support corresponding battery cell capacities. In the illustrated embodiment hX>hY>hZ, meaning that for the battery capacities have a similar order: X>Y>Z. With this arrangement, the multi-function unit provides system operation and populating guidelines. The battery cell supports on the stacking structures define the locations/depth of the battery cells, the way multiple cells are stacked and the depths of each battery cell below the fluid level.

Multi-function unit 108 can also include other components. In an embodiment that uses liquid-level sensors L (see FIG. 1), the sensors can be attached to or incorporated in the stacking structures 202 or supports 204 at the correct position to sense when the fluid surface 106 of two-phase cooling fluid 104 (see FIG. 1) coincides with the top surface of each battery cell. In the illustrated embodiment only stacking structure 202A has associated sensors L, but in other embodiments more of the stacking structures can include sensors L. Although not shown in this figure, switches S (see FIG. 1) can also be included in multi-function unit 108. As noted above for FIG. 1, the battery cells in each battery stack are supported by a pair of multi-function units 108, but in a given battery stack both multi-function units in the pair need not be identical. For instance, in each pair one multi-function unit can include stacking structures, sensors, and switches, while the other includes only stacking structures.

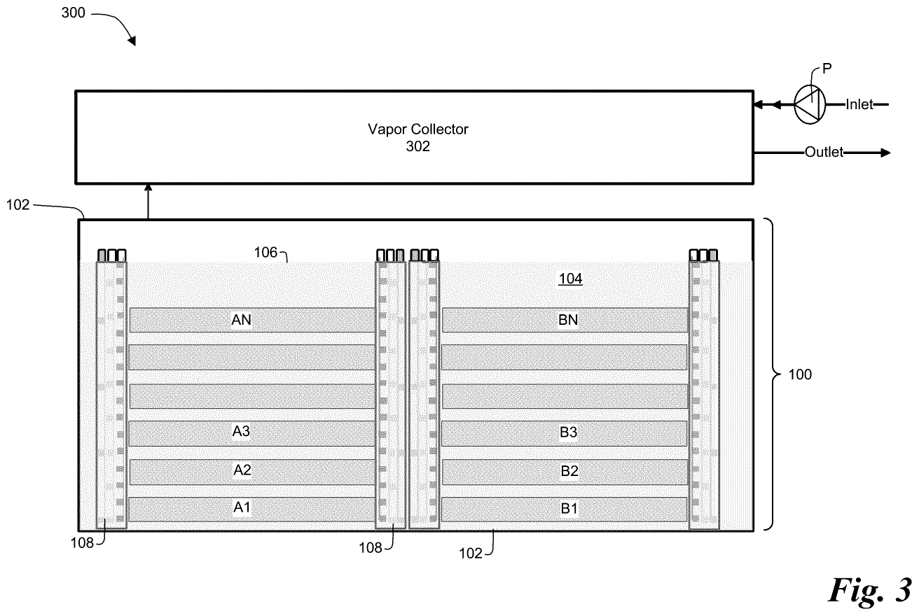

FIG. 3 illustrates an embodiment of a BBU 300. BBU 300 is in most respects similar to BBU 100, and embodiments of BBU 300 can include all the same elements described above for embodiments of BBU 100—including elements such as sensors L, switches S, and controller 112, which for clarity are not shown in this figure.

The primary difference between BBUs 300 and 100 is that BBU 300 includes a vapor collector 302. Vapor collector 302 includes an inlet and an outlet for an external cooling fluid and a pump P fluidly coupled to the inlet to circulate the external cooling fluid through the interior of the vapor collector, speeding the transformation of vapor held in the vapor collector from its vapor phase back to its liquid phase. In the illustrated embodiment vapor collector 302 is an external vapor collector attached to the top of IT container 102, but in other embodiments the vapor collector can be an internal vapor collector positioned in the interior of IT container 102. In still on the other embodiments, the vapor collector can be partially inside and partially outside IT container 102.

Two-phase cooling fluid 104 is generally expensive, so it is desirable to avoid wasting it by allowing it evaporate away into the atmosphere. To capture the vapor phase of two-phase cooling fluid 104 generated during discharge of battery cells, vapor collector 302 is positioned above IT container 102 so that during operation vapor rising from IT container 102 is collected and held in the vapor collector. When the discharge of battery cells within the BU 300 is complete, vapor generated during battery discharge can held in vapor collector 302 until regular power (as opposed to power provided by the battery cells) is restored to the system. When regular power is restored, vapor collector 302 can be operated by switching on pump P to deliver the external cooling fluid to the vapor collector, causing the vapor phase of two-phase cooling fluid 104 held within the vapor collector to return to its liquid phase. As vapor held in vapor collector 302 condenses back into liquid phase, the liquid phase falls by the action of gravity back into IT container 102 and refills the container back to an initial depth S of the liquid phase (see FIG. 1).

FIGS. 4A-4B together illustrate an embodiment of the operation of a BBU 400. BBU 400 is in most respects similar to BBUs 100 and 300, and embodiments of BBU 400 can include all the same elements described above for embodiments of BBUs 100 and 300—including elements such as sensors L, switches S, and controller 112, which for clarity are not shown in these figures. The primary difference between BBU 400 and BBUs 300 and 100 is that in BBU 400 the battery stacks have a different number of batteries: the battery cells in stack A have larger capacities than the battery cells in stack B, as a result of which stack A has fewer battery cells spaced further apart than stack B. In the illustrated embodiment stack A has four battery cells A1-A4 (i.e., N=4) and stack B has seven battery cells B1-B7 (i.e., N=7), but other embodiments can of course have different numbers of battery cells in each stack. In an embodiment, multiple stacks with different capacities can coexist in an enclosure, but the fluid level is designed based on the larger capacity ones.

In operation of BBU 400, the battery cells in each stack are discharged one at a time, beginning with the Nth (topmost) battery cell and proceeding in descending order until the first (bottommost) battery cell in each stack. As the battery cells discharge, heat from the discharging battery cells evaporates two-phase cooling fluid 104, transforming it from its liquid phase to its vapor phase. As a result of evaporation, the depth S of liquid surface 106 (see FIG. 1) decreases during operation, but the heights H (see FIG. 1) of individual battery cells are fixed, so that as depth S decreases, liquid surface 106 eventually coincides with the top surface T of every currently-discharging battery cell. When liquid surface 106 drops so that it substantially coincides with the top surface of a battery cell, that battery cell is shut off (i.e., it stops discharging) and the next battery below it in the stack begins discharging.

As shown in FIG. 4A, at the beginning the topmost battery cells A4 and B7 being to discharge, and liquid surface 106 is in region a for stack A and in region d for stack B. As battery cells A4 and B7 discharge, liquid surface 106 drops. In stack A, battery cell A4 stops discharging when liquid surface 106 reaches the bottom of region a (i.e., when liquid surface 106 coincides with the top surface of A4) and battery cell A3 begins discharging. In stack B, battery cell B7 stops discharging when liquid surface 106 reaches the bottom of region d (i.e., when liquid surface 106 coincides with the top surface of B7) and battery cell B6 begins discharging.

FIG. 4B illustrates the continuing operation when liquid surface 106 has dropped into regions b and f. In stack A, battery cell A3 continues discharging until liquid surface 106 reaches the bottom of region b (i.e., when liquid surface 106 coincides with the top surface of A3), at which point A3 stops discharging and A2 begins discharging. In stack B, liquid surface 106 is in region f, below the top surfaces of B7 and B6, meaning that B7 and B6 have already stopped discharging and B5 is the one currently discharging. Battery cell B5 stops discharging when liquid surface 106 reaches the bottom of region f (i.e., when liquid surface 106 coincides with the top surface of B5). In each stack the process continues until liquid surface 106 reaches the top surfaces battery cells A1 and B1, the lowest battery cells in each stack, at which point the lowest battery cells are switched off and the process is complete. In stack A, then, the battery cells discharge in the sequence A4, A3, A2, and A1, so that fluid region a is dedicated for cooling A4, fluid region b is designed for cooling A3, fluid region c is dedicated for cooling A2, and so on. In stack B, the battery cells discharge in the sequence B7, B6, B5, B4, B3, B2, B1. Stack B func-tions similarly to stack A, with the fluid region above each battery cell dedicated to its cooling.

Discharging the battery cells in this sequence is an efficient way to cool the battery cells without the need for additional power to circulate or cool the fluid. This significantly increases the availabilities of the BBU, especially in backup power mode.

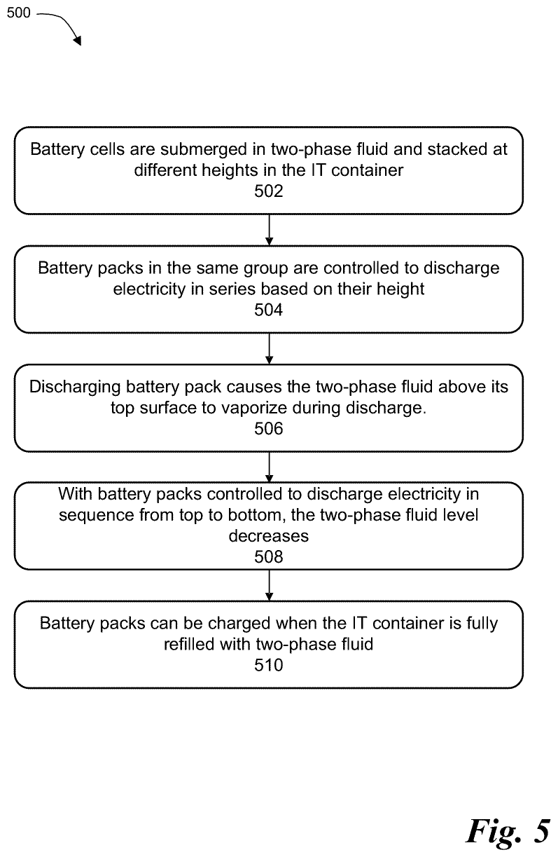

FIG. 5 illustrates an embodiment of a process 500 for operating a BBU such as BBUs 100, 300, and 400. The process begins at block 502, where individual battery cells are stacked at different heights in the IT container and submerged in two-phase fluid. At block 504, battery cells in the same group are controlled to discharge electricity in series based on their height, with the battery cells being discharges in descending order from the topmost battery cell to the bottommost battery cell. At block 506, heat from each discharging battery cell causes the two-phase fluid above its top surface to vaporize. At block 508, as the battery packs discharge electricity in sequence, the surface of the two-phase liquid drops until it reaches each battery cell's top surface, at which point discharge from that battery cell ends and discharge of the next lower battery in the stack begins. At block 510, the battery cells in each stack can be charged when the IT container is fully refilled with two-phase fluid. In embodiments such as BBU 100 and 400, the two-phase fluid will need to be refilled from an external source. In an embodiment such as BBU 300, the two-phase fluid is refilled when the vapor phase of the fluid is returned to liquid phase by the condensing unit.

Other embodiments are possible besides the ones described above. For instance:
The multifunction unit can be designed in different configurations.
The design can be modified to accommodate different battery packs.
The design can be used in mixed server and battery systems.

The above description of embodiments is not intended to be exhaustive or to limit the invention to the described forms. Specific embodiments of, and examples for, the invention are described herein for illustrative purposes, but various modifications are possible.

What is claimed is:

1. A battery backup unit (BBU) comprising:
a battery stack adapted to be submerged in a liquid phase of a two-phase cooling fluid, the battery stack including N battery cells, N≥2, each battery cell having a top surface,
wherein the battery cells are stacked in ascending order, the first battery cell being the lowest battery cell in the battery stack and the Nth battery cell being the highest battery cell in the battery stack, and
wherein an initial distance between a liquid surface of the two-phase cooling fluid and the top surface of the Nth battery cell, and an inter-cell distance between the top surfaces of each pair of consecutive battery cells in the stack, are determined based on storage capacity of the battery cells and thermal properties of the two-phase cooling fluid.

2. The BBU of claim 1 wherein the thermal properties of the two-phase cooling fluid include its specific heat capacity and evaporation rate.

3. The BBU of claim 1 wherein each battery stack further includes a pair of multi-function units, wherein each multi-function unit includes a stacking structure with a set of supports, the distance between supports providing the required inter-cell distance for a given battery cell power capacity, and wherein each battery cell in the battery stack is supported by a pair of corresponding supports, one from each multi-function unit.

4. The BBU of claim 1, further comprising:
N liquid-level sensors, each liquid-level sensor substantially aligned with the top surface of a corresponding battery cell;
N switches, each coupled to a corresponding battery cell; and
a controller communicatively coupled to the N liquid-level sensors and the N switches, wherein the controller uses each switch to turn off the corresponding battery cell when the corresponding liquid-level sensor determines that the top surface of the battery cell is no longer submerged in the two-phase cooling fluid.

5. The BBU of claim 1, further comprising an electrical bus electrically coupled to the N battery cells in the battery stack.

6. The BBU of claim 1, further comprising a vapor collector coupled to a top of the IT container.

7. The BBU of claim 6 wherein the vapor collector is internal, external, or partially internal and partially external.

8. The BBU of claim 6, wherein the vapor collector has a fluid inlet, a fluid outlet, and a pump coupled in the fluid inlet to circulate an external cooling fluid through the vapor collector.

9. The BBU of claim 1, further comprising at least one additional battery stack positioned in the IT container and submerged in the two-phase cooling fluid.

10. The BBU of claim 9 wherein the additional battery stack has M battery cells and wherein M≠N.

11. A process of operating a battery backup unit (BBU), the process comprising:
submerging a battery stack in a liquid phase of a two-phase cooling fluid, the battery stack including N battery cells, N≥2, each battery cell having a top surface, wherein the battery cells are stacked in ascending order, the first battery cell being the lowest battery cell in the battery stack and the Nth battery cell being the highest battery cell in the battery stack;
discharging each battery cell in a sequence starting with the Nth battery cell and proceeding in descending order to the first battery cell, wherein:
each battery cell is electrically discharged until a liquid surface of the two-phase cooling fluid substantially coincides with the top surface of the battery cell; and
when the liquid surface of the two-phase cooling fluid substantially coincides with the top surface of the battery cell, that battery cell stops discharging and a next battery cell in the sequence begins to discharge.

12. The process of claim 11, further comprising determining an initial distance between a surface of the two-phase cooling fluid and the top surface of the Nth battery cell, and an inter-cell distance between the top surfaces of each pair of consecutive battery cells in the stack, based on storage capacity of the battery cells and thermal properties of the two-phase cooling fluid.

13. The process of claim 12 wherein the thermal properties of the two-phase cooling fluid include its specific heat capacity and evaporation rate.

14. The process of claim 11, further comprising supporting each battery cell in the battery stack with at least one multi-function unit having a set of N supports therein, positions of the supports providing an inter-cell distance and an initial distance between a surface of the two-phase cooling fluid and the top surface of the Nth battery cell.

15. The process of claim 11, further comprising:
aligning a liquid-level sensor with the top surface of each battery cell;
coupling a switch to each battery cell; and
turning off each switch when the corresponding liquid-level sensor determines that the top surface of the battery cell is no longer submerged in the two-phase cooling fluid.

16. The process of claim 11, further comprising electrically coupling an electrical bus to the N battery cells in the battery stack.

17. The process of claim 11, further comprising coupling a vapor collector to the IT container.

18. The process of claim 17, further comprising circulating an external cooling fluid through the vapor collector.

19. The process of claim 11, further comprising submerging at least one additional battery stack in the two-phase cooling fluid.

20. The process of claim 19 wherein the additional battery stack has M battery cells wherein M≠N.
